(19) United States
(12) Patent Application Publication
(10) Pub. No.: US 2017/0161446 A1
(43) Pub. Date: Jun. 8, 2017

(54) Systems and Methods for Continuous Optimization of Medical Treatments

(71) Applicant: Sectra AB, Linköping (SE)

(72) Inventor: Torbjörn Kronander, Linkoping (SE)

(21) Appl. No.: 15/366,752

(22) Filed: Dec. 1, 2016

Related U.S. Application Data
(60) Provisional application No. 62/263,283, filed on Dec. 4, 2015.

(51) Int. Cl. G06F 19/00

(52) U.S. Cl. CPC G06F 19/345; G06F 19/325; G06F 19/3431

(57) ABSTRACT

A clinical decision support system and method for improving treatment of a medical condition includes determining a current best practice treatment for the medical condition, deriving a perturbed variation of the current best practice treatment, identifying a plurality of new treatment outcomes resulting from treatment of a plurality of patients via the perturbed variation of the current best practice treatment, and deriving a new best practice treatment based on the plurality of new treatment outcomes. The perturbed variation of the current best practice may be small enough so as not to require patient consent, or may be sufficiently large so as to require patient consent.

### RELATED APPLICATION

This application claims the benefit of and priority to U.S. Provisional Patent Application No. 62/263,283 filed Dec. 4, 2015, the disclosure of which is incorporated herein by reference as if set forth in its entirety.

### FIELD OF THE INVENTION

The present invention relates generally to healthcare and, more particularly, to improving healthcare outcomes for patients.

### BACKGROUND OF THE INVENTION

Evidence based medicine is the norm and medical professionals acting without evidence are, typically, looked down upon. But evidence-building has its limitations. In order to be trustworthy for medical decision-making, the evidence typically is based on studies across large cohorts. The broad cohorts are, however, in conflict with the precision medicine objective of modern healthcare. Metabolism is not the same between adults and children, between sexes and, to some extent, between races. Building sufficient evidence in order to justify new medicines or treatments for all these subgroups is a difficult task.

In addition, healthcare is evolving into personalized medicine, where the individual genotype and phenotype for each patient is the basis for treatment. Thus, the subgroups for treatment become very small, or treatment is based on certain characteristics of DNA common to large groups. As such, building evidence can be difficult and expensive.

Furthermore, few variations of treatment can be studied. The studies are designed to have sufficient statistical power, which typically means that merely two or three alternatives can be included. For instance, a drug may be evaluated with the alternatives “full dose” and “no dose.” Thus, only two points on the dose scale are tested, whereas the optimum may very well be in-between or even above the selected dose.

Moreover, in order to build evidence one typically studies one treatment or substance at a time. While many patients today have a spectrum of medications, very little is typically known of the interactions of these medications. There is a risk that many drugs do more harm than good in certain combinations with other drugs. Contemporary evidence building methodology does not lend itself to discover such interdependencies as the number of combinations increase astronomically when there are many substances around and there is no possibility to study them all in large statistically sound studies.

Typically, evidence is created in controlled clinical trials. However, because the size and complexity of these studies necessarily must be large in order to support modern healthcare, the costs involved may be prohibitively large. Currently, there are several initiatives to create large volunteer cohorts, including the twenty thousand (20,000) person U.K. biobank, the thirty thousand (30,000) person Swedish SCAPIS (Swedish CArdioPulmonary biolmage Study) project, and the proposed one million (1,000,000) person U.S. Precision Medicine Initiative (PMI) (https://www.nih.gov/precision-medicine-initiative-cohort-program). Much useful medical knowledge can be created through these cohorts, but such cohorts are far from a solution for the overall evidence creation needs for conventional medical treatments.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Embodiments of the present invention provide an alternative way of generating evidence and steering medical practices towards improved quality of care. According to aspects of the present invention, the process of creating medical evidence by large studies can be complemented by a continuous small improvement of outcomes, which can be beneficial for both the improvement rate of healthcare and the return on investment ratio for improvement efforts.

Embodiments of the present invention also contribute to clinical decision-making. Currently, this is often assisted by best practice guidelines developed on the basis of (often several) research studies, but also there are many individual adjustments controlled by the treating physician, as well as many cases where there are no established guidelines.

According to some embodiments of the present invention, a method of selecting a treatment for a patient having a medical condition includes receiving at a clinical decision support system (CDSS) an identification of the patient and the medical condition from a healthcare provider. The CDSS electronically obtains medical information about the patient and evidence of treatment outcomes for other patients having the medical condition, and then electronically determines a current best practice treatment for the medical condition. The CDSS electronically derives a perturbed variation of the current best practice treatment, and proposes the perturbed variation of the current best practice treatment to the healthcare provider. In some embodiments, the perturbed variation of the current best practice treatment is derived via the formula W̅ᵢ=\hat{V}ᵢ+p̅ᵢ, wherein p̅ᵢ is a perturbation vector, \hat{V}ᵢ is a best practice treatment vector, and W̅ᵢ is a suggested treatment. Typically, the perturbed variation of the current best practice treatment does not substantially increase a risk of a worse outcome than may occur with the current best practice.

In some embodiments, the perturbed variation of the current best practice is small enough so as not to require patient consent. In other embodiments, the perturbed variation of the current best practice treatment is sufficiently large so as to require patient consent. The perturbed variation may be derived via one or more of the following: a gradient climb algorithm, a simulated annealing algorithm, and a genetic algorithm. In some embodiments, information is provided on risk for adverse effects of the proposed new best practice treatment, and the perturbed variation is modulated to avoid known treatment risks.

In some embodiments, the current best practice treatment includes first and second treatments. The CDSS electronically randomly selecting one of the first or second treatments, electronically derives a perturbed variation of the selected one of the first and second treatments, and then proposes the perturbed variation of the selected one of the first and second treatments to the healthcare provider.

According to some embodiments of the present invention, a method of improving treatment of a medical condition includes utilizing a CDSS to determine a current best practice treatment for the medical condition, derive a plurality of perturbed variations of the current best practice treatment, identify a plurality of new treatment outcomes resulting from treatment of a plurality of patients, each receiving one of the plurality of perturbed variations of the current best practice treatment, and derive a new best practice treatment based on the plurality of new treatment outcomes. The current best practice treatment is the one where available evidence corresponds to the most favorable predicted outcome for a patient. Typically, the perturbed variation of the current best practice treatment does not increase a risk of a worse outcome than may occur with the current best practice.

In some embodiments, the current best practice treatment includes first and second treatments. The CDSS electronically randomly selects one of the first or second treatments, and electronically derives a perturbed variation of the selected one of the first and second treatments. A plurality of new treatment outcomes resulting from treatment of a plurality of patients via the perturbed variation of each of the first and second treatments are identified and then a new best practice treatment is derived based on the plurality of new treatment outcomes.

In some embodiments, the current best practice treatment includes first and second treatments. The CDSS electronically derives a plurality of perturbed variations of each of the first and second treatments, electronically identifies a plurality of new treatment outcomes resulting from treatment of a plurality of patients each receiving one of the plurality of perturbed variations of either of the first and second treatments, and then electronically derives a proposed new best practice treatment based on the plurality of new treatment outcomes.

A CDSS according to some embodiments of the present invention, includes at least one processor and memory that stores instructions that, when executed by the at least one processor, cause the at least one processor to perform the following operations: determining a current best practice treatment for a medical condition, deriving a plurality of perturbed variations of the current best practice treatment, identifying a plurality of new treatment outcomes resulting from treatment of a plurality of patients each receiving one of the plurality of perturbed variations of the current best practice treatment, and deriving a new best practice treatment based on the plurality of new treatment outcomes. The perturbed variation of the current best practice treatment is derived via the formula W̅ᵢ=\hat{V}ᵢ+p̅ᵢ, wherein p̅ᵢ is a perturbation vector, \hat{V}ᵢ is a best practice treatment vector, and W̅ᵢ is a suggested treatment. In some embodiments, the perturbed variation of the current best practice treatment does not substantially increase a risk of a worse outcome than may occur with the current best practice.

In some embodiments, information is provided on risk for adverse effects of the perturbed variation of the current best practice treatment, and the perturbed variation is modulated to avoid known treatment risks.

A CDSS according to some embodiments of the present invention, includes at least one processor and memory that stores instructions that, when executed by the at least one processor, cause the at least one processor to perform the following operations: receiving an identification of the patient and the medical condition from a healthcare provider, electronically obtaining medical information about the patient and evidence of treatment outcomes for other patients having the medical condition, electronically determining a current best practice treatment for the medical condition, electronically deriving a perturbed variation of the current best practice treatment, and proposing the perturbed variation of the current best practice treatment to the healthcare provider. In some embodiments the perturbed variation of the current best practice treatment is derived via the formula W̅ᵢ=\hat{V}ᵢ+p̅ᵢ, wherein is a perturbation vector, \hat{V}ᵢ is a best practice treatment vector, and W̅ᵢ is a suggested treatment. In some embodiments, the perturbed variation of the current best practice treatment does not substantially increase a risk of a worse outcome than may occur with the current best practice.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate various embodiments of the present invention. The drawings and description together serve to fully explain embodiments of the present invention.

FIG. 1 is a graph illustrating an unknown outcome function O across treatment alternatives, and wherein two treatments and their outcomes are known.

FIG. 2 is a graph illustrating an unknown outcome function O across treatment alternatives, and wherein three treatments and their outcomes are known.

FIGS. 3-4 are schematic illustrations of a CDSS configured to communicate with physicians and provide perturbed variations of medical treatments, according to some embodiments of the present invention.

FIG. 5 is a flow chart illustrating a feedback loop in which healthcare improvements are materialized, in accordance with embodiments of the present invention.

FIG. 6 is a schematic illustration of a data processing circuit or system, according to some embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain layers, components or features may be exaggerated for clarity, and broken lines illustrate optional features or operations unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

As used herein, the term “and/or” includes any and all combinations of one or more of the associated listed items and may be abbreviated as “/”.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/−twenty percent (20%).

The term “circuit” refers to software embodiments or embodiments combining software and hardware aspects, features and/or components, including, for example, at least one processor and software associated therewith embedded therein and/or executable by and/or one or more Application Specific Integrated Circuits (ASICs), for programmatically directing and/or performing certain described actions, operations or method steps. The circuit can reside in one location or multiple locations, it may be integrated into one component or may be distributed, e.g., it may reside entirely in a workstation or single computer, partially in one workstation, cabinet, or computer, or totally in a remote location away from a local display at a workstation. If the latter, a local computer and/or processor can communicate over a LAN, WAN and/or internet.

The term “clinical decision support system” (CDSS) refers to a health information technology system that is designed to provide physicians and other health professionals with clinical decision support (CDS), that is, assistance with clinical decision-making tasks.

The context of aspects of the present invention is an arbitrary clinical scenario where the clinical decision for a patient involves a number of possible treatment actions, where each action has several options. For instance, an action can be to prescribe a certain drug, and the options are the different dose and frequency regimes. The task of the physician is to decide on a treatment, referred to herein as a treatment vector (where each element corresponds to a decision for the specific action). A proposed treatment vector is designated herein as V̅. The treatment results in an outcome O for a patient P. Thus, in mathematical terms, the outcome is a function O(V̅,P).

What counts as a positive outcome can be defined in different ways. The appropriateness of outcome measures depend on the medical scenario. Common measures of positive outcome include survival as such, long survival times, high quality-of-life (often measured through questionnaires), no disease recurrence, and slow disease progression, but other measures can also be relevant.

According to some embodiments of the present invention, outcome is condensed into a single number, where a higher number means a better outcome. Examples of such numerical representation include: better outcomes can correspond to denoting survival as a binary entity with 1=survival and 0=death, can correspond to survival times being a number of months or years longer, to a quality-of-life difference of 0.01 up to 1.0 (using the standard quality-of-life scale of 1.0=perfect health and 0.0=dead), to denoting disease recurrence as a binary entity with 1=no recurrence and 0=recurrence, and to giving disease progression stages a decreasing numerical scale, for example in Alzheimer's disease, denoting 4=no disease, 3=mild cognitive impairment, 2=moderate progression, 1=advanced progression, and 0=dead.

The problem of providing optimal treatment can in mathematical terms be seen as an optimization problem of the outcome function, that is, to maximize the O(V̅,P) over all possible treatment vectors V̅. The task of the physician is to mine the evidence to find out which treatment vector maximizes the outcome for a patient. If the physician is assisted by a clinical decision support system (CDSS), the CDSS can perform the maximization task.

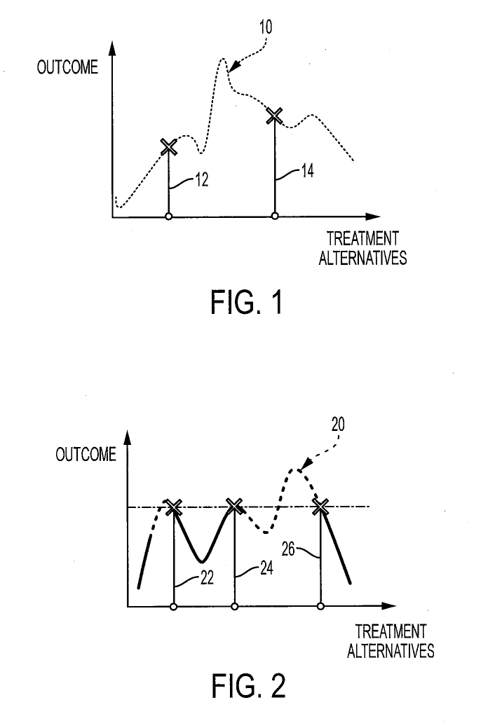

A fundamental limitation of conventional systems is that there are very few points in the space of all possible treatments where there is evidence regarding outcome. Maximizing outcome among the known and tested treatment vectors is doable, but it is likely that the true global maximum of the outcome function lies in the unknown, unchartered regions of the treatment vector space. For example, FIG. 1 illustrates a curve 10 that represents the unknown outcome function a across the treatment alternatives. Traditional evidence creation comparing two treatments 12, 14 merely provides knowledge for two points along the outcome function. It is possible that the optimal treatment alternative is somewhere else along the curve, however. According to embodiments of the present invention, as new possibilities for treatment emerge, fully unchartered dimensions of the treatment vector space are added. Aspects of the present invention strive to continuously progress towards increasingly better outcome for future and/or current patients. Aspects of the present invention constitute a new way of generating medical evidence that corresponds to a deliberate strategy for sampling the treatment vector space.

Embodiments of the present invention may be implemented as a feature of a CDSS.

According to embodiments of the present invention, for a specific patient Pᵢ, the “best practice treatment vector” is denoted as \hat{V}ᵢ, \hat{V}ᵢ. is the vector that, given the current evidence, maximizes outcome. According to embodiments of the present invention, a controlled perturbation of this treatment vector is introduced, as follows: W̅ᵢ=\hat{V}ᵢ+p̅ᵢ. In this equation, p̅ᵢ is a perturbation vector and W̅ᵢ is the suggested treatment from the CDSS.

With the perturbation approach, the sampling of the treatment vector space can be broadened. As outcomes are gathered for the new sampling points, the known part of the outcome function will broaden, which will impact future patients positively. Assume that O(W̅ᵢ) turned out to be the best outcome yet. Then, for patient Pᵢ₊₁, the updated best practice treatment vector will be \hat{V}ᵢ₊₁=W̅ᵢ, and the suggested treatment becomes W̅ᵢ₊₁=\hat{V}ᵢ₊₁+p̅ᵢ₊₁, a new perturbation of the updated best practice vector.

Note that embodiments of the present invention allow outcomes for different patients to be systematically collected and to be electronically communicated into the CDSS.

In one embodiment, the perturbation vector p̅ᵢ is selected to be “small.” That is, the treatment variations are not allowed to introduce substantial increased risk of substantially worse outcome than currently known best practice. The assessment of what constitutes a substantial increased risk is dependent on the medical scenario in question. An example of an interpretation is that substantial increased risk of substantially worse outcome corresponds to more than 5% risk of more than 0.05 lower quality-of-life (in the standard 1.0-0.0 scale) compared to current best practice. This balance between treatment variations being large enough to support progress for future patients, but small enough to avoid adverse effects for the patient at hand, is delicate and must be carefully controlled. Nevertheless, small variations are already naturally occurring in healthcare, for instance when a coarsely defined drug dose (e.g., “a pill a day”) is administered not accounting for body weight or gender. The small perturbation may be particularly useful if it can be designed and controlled such that patient consent is not necessary, since it can then be more broadly used and potentially yield more reliable conclusions on improvements.

Some embodiments of the present invention utilize large perturbations as a bipolar approach with two baseline treatment vectors (the old and the new) that are “far apart” from each other. This is the case when there are two quite separate patient management options for a disease, which is common in health care. Among a wealth of examples, one is ruptured Achilles tendons where the main treatment options include surgery or a non-surgical approach. Another example is to treat morbid obesity with gastric bypass surgery or with instructions for diet and physical exercise. Small variations around these treatment vector nodes are then induced. These small variations are different from a traditional clinical trial.

According to other aspects of the present invention, a “large” perturbation vector p̅ᵢ can be utilized in order to allow larger/greater improvements of treatment outcomes (e.g., longer survival rate, better quality of life, etc.). This can be compared to a traditional clinical trial wherein a treatment substantially different from the current best practice is evaluated. For the example of drug treatment, a large perturbation could, for instance, correspond to untested combinations of different drugs, to medication doses of 2-100 times the current practice, to administration of medication across time periods 2-10 times shorter or longer than current practice, or to a combination of all these perturbations. Large perturbations are particularly feasible in the case of severe disease with ineffective treatment(s) available. One such example is amyotrophic lateral sclerosis (ALS). There are many potential targets for drug therapy to combat ALS: glutamate-induced excitotoxicity, inflammation, mitochondrial dysfunction, oxidative stress, protein aggregation, transcription deregulation, and epigenetic modifications. As for many complex diseases, it is reasonable to believe that the most effective treatment will be a combination of therapeutic approaches. A large perturbation scheme according to embodiments of the present invention could consist of exploring vastly different combinations of existing medication, each drug targeting a different therapeutic hypothesis.

An increased risk of significantly worse outcomes can be associated with large perturbations, and patient consent is therefore necessary. It can be noted, however, that the ethical considerations is, in essence, no different from the ethical rationale that underpins the current practice of clinical trials where the new treatments also have unknown effects. In addition, treatments known to be inappropriate should of course never be suggested by the system.

According to other embodiments of the present invention, any combination, also varying over time, of “small” and “large” perturbation vectors p̅ᵢ can be used, as for instance is the case in some mathematical optimization techniques.

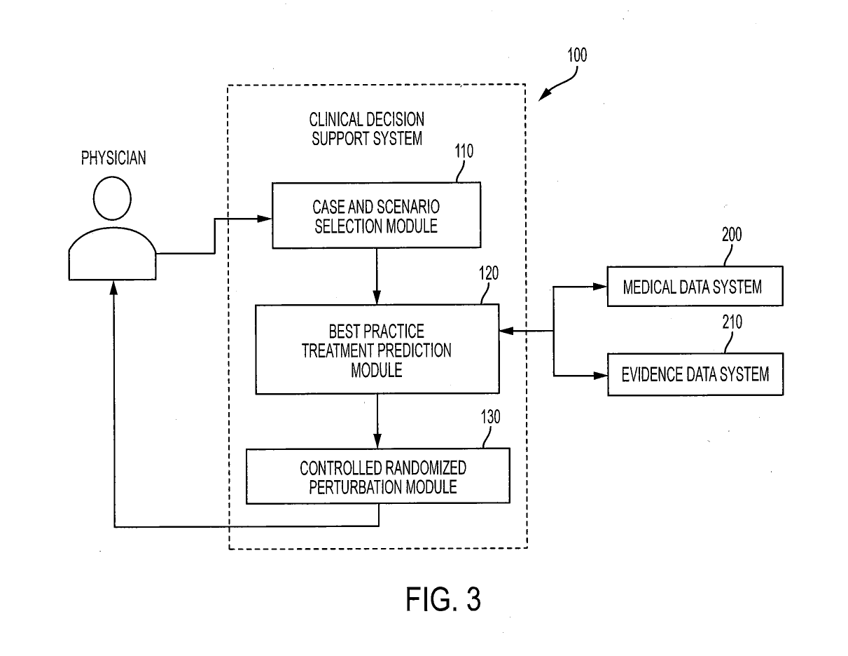

To summarize, a perturbation vector p̅ᵢ according to embodiments of the present invention can be generated in different ways. It may often be appropriate to keep a perturbation vector close to current best practice and far from known inappropriate outcome points. A useful property is that several “good practices” can co-exist in this model, as illustrated in FIG. 2. In FIG. 2, curve 20 represents the outcome function O across the treatment alternatives. Curve 20 is dashed where there are unknown outcomes and solid where the outcomes are known from evidenced-based studies. In FIG. 2, there are three treatment options 22, 24, 26 representing the best outcome (Shown as each having the same outcome). Aspects of the present invention allow exploring treatment variations across all three “good practices” (i.e., 22, 24, 26) simultaneously, which can lead to the discovery that the global optimum is a variation of the treatment option 26. The treatments suggested can then be variations centered around these good practice points (i.e., 22, 24, 26), exploring which practice that has the potential to improve further. An example is the bipolar approach described above.

The perturbation vector p̅ᵢ can be generated according to several principles from standard optimization methods. Gradient climb, simulated annealing or genetic algorithms are a few possibilities. Gradient climb, also referred to as hill climbing, algorithms are described, for example, by Russell and Norvig in “Artificial Intelligence: A Modern Approach”, which is incorporated herein by reference in its entirety. Simulated annealing algorithms are described, for example, by Laarhoven and Arts in “Simulated annealing: Theory and applications”, which is incorporated herein by reference in its entirety. Genetic algorithms are described, for example, by David Goldberg in “Genetic Algorithms in Search, Optimization, and Machine Learning”, which is incorporated herein by reference in its entirety. It may be important to have a random component in a treatment perturbation, in order to obtain a meaningful sampling of a treatment vector space.

Embodiments of the present invention lead to a learning medical treatment system that will strive to continuously optimize treatments for small subgroups. Instead of knowledge of average outcomes for a large cohort, that is a blunt decision support tool for the individual patient, the present invention can lead to decision support based on precise predictions for a relevant subgroup for the individual patient, for instance in terms of age, gender, race, certain genes, and medical history events. In fact, such a learning system may behave similarly to biological evolution, where each new individual is the output of the parents as well as a small random alternation, and the evolutionary process will promote the most successful new paths of development for the species. In the present invention, metaphorically speaking, the current best practices would be the “parents”, the random alteration corresponds to the perturbation vector, the suggested treatments W̅ᵢ are the “children”, and evaluation of outcomes constitute the evolutionary selection.

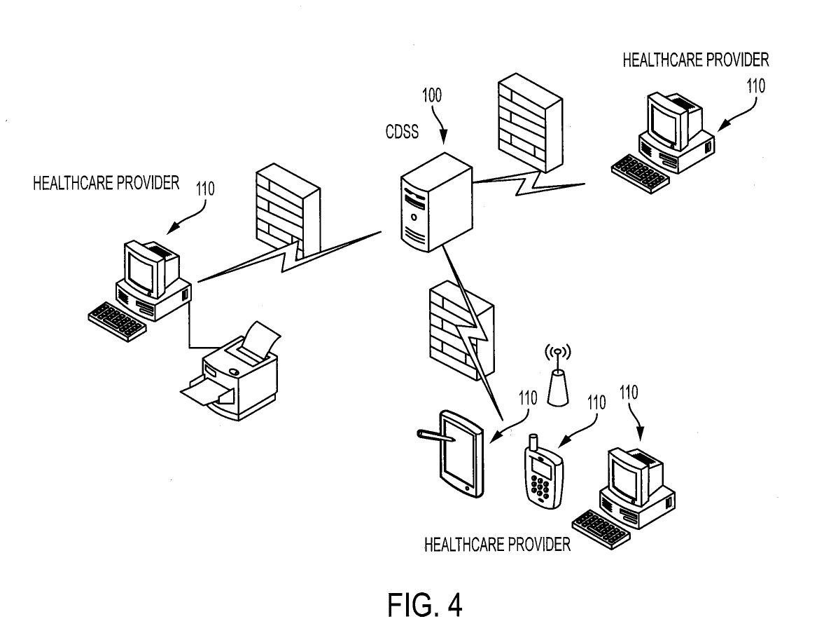

Referring to FIG. 3, a CDSS 100 according to some embodiments of the present invention is illustrated. The CDSS 100 is in communication with a medical data system 200 and an evidence data system 210. The CDSS 100 can communicate with the medical data system 200 and evidence data system 210 via a computer network, such as one or more of local area networks (LAN), wide area networks (WAN), via a private intranet and/or via the public Internet. The CDSS 100 can communicate with the medical data system 200 and evidence data system 210 via wired or wireless connections. The CDSS 100 can be remote from both the medical data system 200 and evidence data system 210. Alternatively, the CDSS 100 can be onsite with one or both of the medical data system 200 or evidence data system 210.

The CDSS 100 may be embodied as a standalone server or may be contained as part of other computing infrastructures. The CDSS 100 may be embodied as one or more enterprise, application, personal, pervasive and/or embedded computer systems that may be standalone or interconnected by a public and/or private, real and/or virtual, wired and/or wireless network including the Internet, and may include various types of tangible, non-transitory computer-readable media.

The CDSS 100 can be provided using cloud computing which includes the provision of computational resources on demand via a computer network. The resources can be embodied as various infrastructure services (e.g. compute, storage, etc.) as well as applications, databases, file services, email, etc. In the traditional model of computing, both data and software are typically fully contained on the user's computer; in cloud computing, the user's computer may contain little software or data (perhaps an operating system and/or web browser), and may serve as little more than a display terminal for processes occurring on a network of external computers. A cloud computing service (or an aggregation of multiple cloud resources) may be generally referred to as the “Cloud”. Cloud storage may include a model of networked computer data storage where data is stored on multiple virtual servers, rather than being hosted on one or more dedicated servers.

A physician/healthcare provider communicates with the CDSS 100 via an electronic device 110 (FIG. 4), such as a personal computer, laptop computer, smart phone, tablet, PDA, and the like. For example, a physician communicates patient-specific data about a patient's medical condition to the CDSS 100, and the physician receives a perturbed variation of a medical treatment for the medical condition from the CDSS 100. The physician's electronic device may communicate with the CDSS 100 via a computer network, such as one or more of local area networks (LAN), wide area networks (WAN), via a private intranet and/or via the public Internet. The physician's electronic device may communicate with the CDSS 100 via wired or wireless connections. Preferably, data transfer between the physician's electronic device and the CDSS 100 is encrypted and is done using any appropriate firewalls to comply with industry or regulatory standards such as HIPAA. The term “HIPAA” refers to the United States laws defined by the Health Insurance Portability and Accountability Act.

In some embodiments the physician would send to the CDSS input identifiers for a patient for which a medical decision is to be taken. This input could be performed via manual input or could be inferred via functions in patient information system, such as an Electronic Health Record (EHR) system. The physician would also include in the CDSS input which type of decision support that is requested. The information the physician receives back from the CDSS is a suggestion for how the patient should be treated and managed. Optionally, the CDSS could also provide information on the rationale for the suggestion, predicted outcomes of the treatment, information about risks for adverse effects that have been considered in the suggestion, information about the uncertainty of the prediction, information about the sensitivity of the treatment assessment, e.g., what factors that if altered would impact the assessment most, and/or alternative treatment options, etc.

In the illustrated embodiment, the CDSS 100 includes a case and scenario selection module 110, a best practice treatment prediction module 120, and a controlled randomized perturbation module 130. According to embodiments of the present invention, a physician (or other appropriate healthcare provider, such as a physician assistant or nurse practitioner, for example) initiates a procedure for treatment decision-making for a patient via the case and scenario selection module 110. The best practice treatment prediction module 120 then retrieves medically relevant data for the patient from a medical data system 200. The medical data system 200 can be an external source, or a CDSS internal source. In addition, the best practice treatment prediction module 120 retrieves evidence of treatment outcomes from an evidence data system 210. The evidence data system 210 can be an external source, or a CDSS internal source. The CDSS 100 then determines the “best practice” treatment (the one where available evidence corresponds to the most favorable predicted outcome for the patient). The CDSS 100, via the controlled randomized perturbation module 130, derives a perturbed variation of the treatment, which is proposed to the physician.

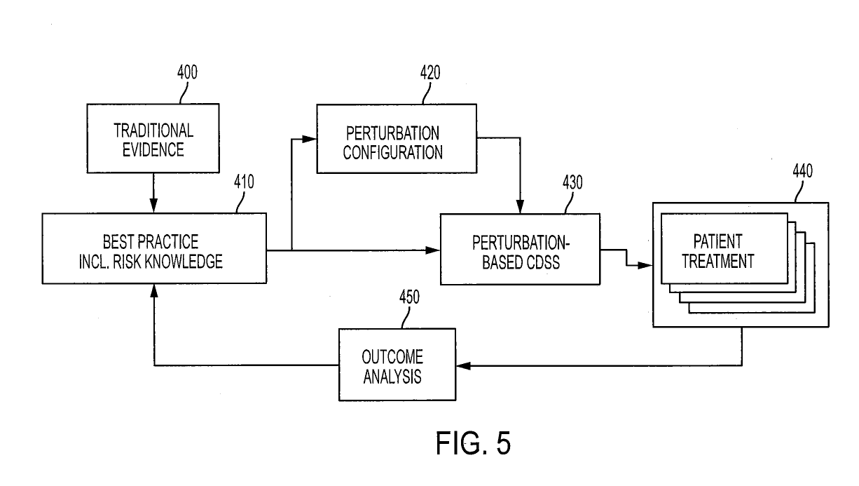

FIG. 5 schematically illustrates a feedback loop in which healthcare treatment improvements are generated via the use of perturbations in medical treatments, in accordance with embodiments of the present invention. This workflow illustration shows the continuous and iterative improvement process towards evolved treatments that lead to improved outcomes. Traditional medical treatment evidence (Block 400), for example from evidence data system 210 (FIG. 3), and current best practice treatment information, including risk knowledge, are input into a perturbation-based CDSS (Block 430), such as CDSS 100 (FIG. 3). A perturbation vector is selected via a perturbation configuration (Block 420), as described above. The CDSS utilizes the perturbation vector to recommend a modified patient treatment (Block 440) for the medical condition. The outcome of the modified patient treatment is monitored and analyzed (Block 450) and used to update the best practice (Block 410). Further iterations of the process then occur. Thus, this process constitutes a controlled closed loop for systematic improvement of healthcare. This workflow would exist in many instances, one for each targeted medical decision scenario. Workflow instances can work in parallel but also be temporarily combined, permanently merged, or split into several instances according to how they best support the medical decision scenarios that present themselves.

As discussed above, embodiments of the present invention may take the form of an entirely software embodiment or an embodiment combining software and hardware aspects, all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices. Some circuits, modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Computer program code for carrying out operations of data processing systems, method steps or actions, modules or circuits (or portions thereof) discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. The program code may execute entirely on one computer, partly on one computer and partly on another computer (local or remote). Local and remote computers may be connected through a local area network (LAN) or a wide area network (WAN), or the connection may be made through the Internet using an Internet Service Provider.

The present invention is described in part with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing some or all of the functions/acts specified in the flowchart and/or block diagram block or blocks.

The flowcharts and block diagrams of certain of the figures herein illustrate exemplary architecture, functionality, and operation of possible implementations of embodiments of the present invention. In this regard, each block in the flow charts or block diagrams represents a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order or two or more blocks may be combined, depending upon the functionality involved.

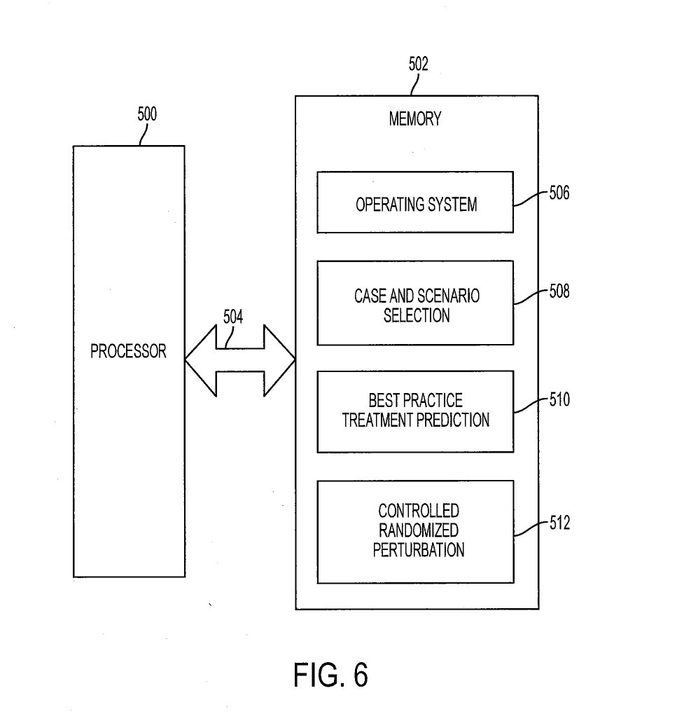

FIG. 6 illustrates an exemplary processor 500 and memory 502 of a data processing system that may be used to implement the functions of the CDSS 100 of FIGS. 3-5 according to some embodiments of the present invention. The processor 500 communicates with the memory 502 via an address/data bus 504. The processor 500 may be, for example, a commercially available or custom microprocessor. The memory 502 is representative of the overall hierarchy of memory devices containing the software and data used to implement various functions of the CDSS 100 (FIGS. 3-5) as described herein. The memory 502 may include, but is not limited to, the following types of devices: cache, ROM, PROM, EPROM, EEPROM, flash, SRAM, and DRAM.

As shown in FIG. 6, the memory 502 may hold various categories of software and data: an operating system 506, a case and scenario selection module 508, a best practice treatment prediction module 510, and a controlled randomized perturbation module 512. The operating system 506 controls operations of one or more data processors that implement the CDSS 100 (FIGS. 3-4). In particular, the operating system 506 may manage the resources of the CDSS 100 and may coordinate execution of various programs (e.g., the case and scenario selection module 508, the best practice treatment prediction module 510, and the controlled randomized perturbation module 512, etc.) by the processor 500.

The case and scenario selection module 508 comprises logic for receiving an identification of a patient and information about a medical condition of the patient from a healthcare provider. This module receives input from the physician on the particular scenario for the requested decision support. In this way the physician may tailor the type of suggested management to be output by the system. The module could also allow the physician to tailor which parts of the patient history that are to be considered in the treatment prediction.

The best practice treatment prediction module 510 comprises logic for obtaining medical information about a particular patient and evidence of treatment outcomes for other patients having the medical condition of the patient. In addition, the best practice treatment prediction module 510 comprises logic for determining a current best practice treatment for the medical condition. This module can be characterized as what currently is considered a CDSS. Thus, novel aspects of embodiments of the present invention are represented by the case and scenario selection module 508 and the controlled randomized perturbation module 512, which extend the traditional CDSS definition.

The controlled randomized perturbation module 512 comprises logic for deriving a perturbed variation of the current best practice treatment and for proposing the perturbed variation of the current best practice treatment to a healthcare provider. As previously described, there are several possible ways to configure the perturbation depending on what is appropriate for the specific decision support scenario. The module also collects and produces information about the CDSS processing to be presented to the physician if he/she requests it. This information could include decision rationale and different types of auxiliary information regarding the outcome analysis, as described above

### Example 1: Migraine Drug Prescription

Assume that for a certain condition, e.g., a migraine condition, there are indications that a drug used for another purpose, e.g., asthma, could be beneficial. The physician needs to decide if the drug should be prescribed for the migraine patient and at what dose. The traditional way would be to either prescribe the drug at the dose recommended for asthma or to not prescribe the drug. According to the present invention, a CDSS 100 can suggest the medication and provide a dose randomly selected in the range of zero (0) times to two (2) times the dose recommended for asthma. When analyzing the outcomes for a number of patients treated, the optimal dose level for different patient groups can be retrieved and the CDSS 100 can be updated to suggest an optimal level with little or no perturbation.

### Example 2: Dietary Instructions for Kidney Stone

Assume that for a certain condition, e.g., kidney stones, little is known about the effect of treatment in terms of dietary instructions for what foods to avoid, as there are many possible causes and also certain combinations of foods could be the cause. The traditional way would be to instruct the patient to avoid a wide range of foods to avoid risk, potentially causing far-reaching challenges for everyday life. According to embodiments of the present invention, a CDSS 100 can propose a random selection of a few foods to avoid, which would likely result in better patient adherence. When analyzing the outcomes for a number of patients treated, the optimal dietary instructions for different patient groups can be retrieved and the CDSS 100 can be updated to suggest the improved diets with little or no perturbation.

### Example 3: Achilles Tendon Surgery and Management (Bipolar Scenario)

Assume that for a certain injury, e.g., a ruptured Achilles tendon, there are two main management options with or without surgery. There are also a number of minor management options, such as the number of days a patient's leg should remain in a cast, the angle the foot should have in the cast, and when the patient should start to put weight on the leg. Traditional management would be to adopt a single recommendation and apply it to all cases. According to embodiments of the present invention, a CDSS 100 could randomly select between the main management options (with or without surgery), and suggest the minor management choices based on random perturbations of the current best practice guidelines within certain bounds. For example, if the best practice is forty (40) days in a cast at a one hundred ten degree (110°) angle with weight-bearing starting at twenty (20) days, the CDSS 100 can propose a variation within +/−10%, that is, thirty six to forty four (36-44) days, ninety nine to one hundred twenty one degrees (99°-121°), and eighteen to twenty two (18-22) days, respectively. When analyzing the outcomes for a number of patients treated, the optimal combination of major and minor management approaches for different patient groups can be retrieved and the CDSS 100 can be updated to suggest only the best major approach and a smaller perturbation around the new best practice in the minor management choices.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A method of improving treatment of a medical condition, the method comprising:
determining a current best practice treatment for the medical condition;
electronically deriving a plurality of perturbed variations of the current best practice treatment;
electronically identifying a plurality of new treatment outcomes resulting from treatment of a plurality of patients each receiving one of the plurality of perturbed variations of the current best practice treatment; and
deriving a proposed new best practice treatment based on the plurality of new treatment outcomes.

2. The method of claim 1, wherein the perturbed variation of the current best practice treatment does not require patient consent.

3. The method of claim 1, wherein the perturbed variation of the current best practice treatment requires patient consent.

4. The method of claim 1, wherein the perturbed variation of the current best practice treatment does not substantially increase a risk of a worse outcome than may occur with the current best practice.

5. The method of claim 1, wherein the current best practice treatment includes first and second treatments, and wherein the method further comprises:
electronically deriving a plurality of perturbed variations of each of the first and second treatments;
electronically identifying a plurality of new treatment outcomes resulting from treatment of a plurality of patients each receiving one of the plurality of perturbed variations of either of the first and second treatments; and
electronically deriving a proposed new best practice treatment based on the plurality of new treatment outcomes.

6. The method of claim 1, wherein the perturbed variation is derived via one or more of the following: a gradient climb algorithm, a simulated annealing algorithm, and a genetic algorithm.

7. The method of claim 1, further comprising providing information on risk for adverse effects of the proposed new best practice treatment, and modulating the perturbed variation to avoid known treatment risks.

8. A method of selecting a treatment for a patient having a medical condition, the method comprising:
receiving an identification of the patient and the medical condition from a healthcare provider;
electronically obtaining medical information about the patient and evidence of treatment outcomes for other patients having the medical condition;
electronically determining a current best practice treatment for the medical condition;
electronically deriving a perturbed variation of the current best practice treatment; and
proposing the perturbed variation of the current best practice treatment to the healthcare provider.

9. The method of claim 8, wherein the perturbed variation of the current best practice treatment does not require consent from the patient.

10. The method of claim 8, wherein the perturbed variation of the current best practice treatment requires consent from the patient.

11. The method of claim 8, wherein the perturbed variation of the current best practice treatment does not substantially increase a risk of a worse outcome than may occur with the current best practice.

12. The method of claim 8, further comprising providing information on risk for adverse effects of the perturbed variation of the current best practice treatment, and modulating the perturbed variation to avoid known treatment risks.

13. The method of claim 8, wherein the current best practice treatment includes first and second treatments, and wherein the method further comprises:
electronically randomly selecting one of the first or second treatments;
electronically deriving a perturbed variation of the selected one of the first and second treatments; and
proposing the perturbed variation of the selected one of the first and second treatments to the healthcare provider.

14. A clinical decision support system, comprising:
at least one processor; and
a memory that stores instructions that, when executed by the at least one processor, cause the at least one processor to perform operations comprising:
determining a current best practice treatment for a medical condition;
deriving a plurality of perturbed variations of the current best practice treatment;
identifying a plurality of new treatment outcomes resulting from treatment of a plurality of patients each receiving one of the plurality of perturbed variations of the current best practice treatment; and
deriving a proposed new best practice treatment based on the plurality of new treatment outcomes.

15. The clinical decision support system of claim 14, wherein the perturbed variation of the current best practice treatment does not substantially increase a risk of a worse outcome than may occur with the current best practice.

16. The clinical decision support system of claim 14, wherein the memory stores instructions that, when executed by the at least one processor, cause the at least one processor to perform operations comprising:
providing information on risk for adverse effects of the perturbed variation of the current best practice treatment; and
modulating the perturbed variation to avoid known treatment risks.

17. The clinical decision support system of claim 14, wherein the current best practice treatment includes first and second treatments, and wherein the memory stores instructions that, when executed by the at least one processor, cause the at least one processor to perform operations comprising:
deriving a plurality of perturbed variations of each of the first and second treatments;
identifying a plurality of new treatment outcomes resulting from treatment of a plurality of patients each receiving one of the plurality of perturbed variations of either the first and second treatments; and
deriving a new best practice treatment based on the plurality of new treatment outcomes.

18. A clinical decision support system, comprising:
at least one processor; and
a memory that stores instructions that, when executed by the at least one processor, cause the at least one processor to perform operations comprising:
receiving an identification of a patient and a medical condition of the patient from a healthcare provider;
electronically obtaining medical information about the patient and evidence of treatment outcomes for other patients having the medical condition;
electronically determining a current best practice treatment for the medical condition;
electronically deriving a perturbed variation of the current best practice treatment; and
proposing the perturbed variation of the current best practice treatment to the healthcare provider.

19. The clinical decision support system of claim 18, wherein the memory stores instructions that, when executed by the at least one processor, cause the at least one processor to perform operations comprising:
providing information on risk for adverse effects of the perturbed variation of the current best practice treatment; and
modulating the perturbed variation to avoid known treatment risks.

20. The clinical decision support system of claim 18, wherein the current best practice treatment includes first and second treatments, and wherein the memory stores instructions that, when executed by the at least one processor, cause the at least one processor to perform operations comprising:
randomly selecting one of the first or second treatments;
deriving a perturbed variation of the selected one of the first and second treatments; and
proposing the perturbed variation of the selected one of the first and second treatments to the healthcare provider.
